(19) United States
(12) Patent Application Publication
(10) Pub. No.: US 2025/0130438 A1
(43) Pub. Date: Apr. 24, 2025

(54) VARIABLE FOCUS LENS WITH 3D ENVIRONMENT SENSING

(71) Applicant: Essilor International, Charenton-Le-Pont (FR)

(72) Inventors: Denis ROUSSEAU, Charenton-Le-Pont (FR); Konogan BARANTON, Charenton-Le-Pont (FR)

(73) Assignee: Essilor International, Charenton-Le-Pont (FR)

(21) Appl. No.: 18/715,014

(22) PCT Filed: Dec. 5, 2022
(86) PCT No.: PCT/EP2022/084434

§ 371 Date: May 30, 2024

(30) Foreign Application Priority Data
Dec. 3, 2021 (EP) 21306708.5

(51) Int. Cl. G02C 7/08

(52) U.S. Cl. CPC G02C 7/083

(57) ABSTRACT

An optical device that includes an active programmable lens including a first zone configured to provide to a wearer, in standard wearing conditions, a correction of at least one eye based on a prescription, according to a first adjustable dioptric function. The optical device provides first vision distance data corresponding to a first distance between a first object in the environment of the wearer and the active programmable lens, stores vision distance data and at least two predetermined optical power states, each predetermined optical power state corresponding to an optical power value relative to a range of vision distance, and controls the first adjustable dioptric function of the first zone of the active programmable lens by adjusting the first adjustable dioptric function of the first zone of the active programmable lens according to an optical power state based on the provided first vision distance data.

### TECHNICAL FIELD

The disclosure relates to an optical device adapted to be worn by a wearer comprising an active programmable lens, a vision distance data providing means and an optical power controller.

### BACKGROUND

It is known to use several types of progressive lenses to adapt to different activities practiced by the wearer and to its environment.

For example, a wearer may use a first optical device when he is driving and a second optical device when the wearer is working using a computer device. The first optical device is specially adapted to far vision. The second optical device is specially adapted for intermediate distance vision.

Therefore, the wearer requires to change optical device each time that he needs an optical device to be adapted to a particular range of vision distance.

This is complicated for the wearer which requires to constantly have different optical devices to perform comfortably different activities.

Additionally, the wearer is also requested to change of optical device each time he requires an optical device adapted for a different vision distance range.

It is also known to use active lenses which make it possible to dynamically adjust the optical device equipment according to the needs of the wearer.

Active lens implies an important power consumption, when eye tracking is required to measure convergence with sufficient precision and sight direction, and an even more important power consumption if these active lenses are used by presbyopic or myopic wearers. The wearer's prescription and the distance of objects in the environment of the wearer must be known to adapt the power of the lenses and permit clear vision.

Additionally, as eye tracking requires the use of IR (infrared) source of light, providing constantly IR to the eye of the wearer. Some people may be scared to use these devices, even if the IR provided is below a safety level required to not alter the eye and the vision of the wearer. In addition, in a sunny environment, IR technology does not often work well. There is then a need to provide an alternative solution to the wearer.

Additionally, for presbyopic or myopic wearers, the fitting parameters of the optical device are required to ensure to adapt the focus of the lens based on the position of the eye with respect to the lens and the object distances.

Several solutions involving active lenses are known. In these solutions, the lens power is adjusted according to the wearer prescription, and distance with respect to a fixed point or the vergence of the visual axis of both eyes.

However, for these solutions, the wearer's gaze directions are complicated to measure and the accuracy required to measure vergence is very difficult to achieve. Eye tracker is a technology which is not fully reliable and may lead to wrong adaptation of the active lens in the daily life of the wearer. Additionally, eye trackers involve a high-power consumption.

Further, current active lenses solutions have another problem when adapting the lens optical power according to the eye gaze direction. The distribution of the active lens optical power may change according to the gaze directions and/or the object distance.

A known solution to adapt optical power is Alvarez lens. Said lens involves visual discomfort when the wearer looks at a far vision distance and then at a near vision distance. Between the two gaze directions, corresponding to different vision distances, the wearer perceives a global change of optical power involving a dynamic space distortion.

The disclosure aims to provide a solution to the above listed problems.

### SUMMARY

To this end, the disclosure proposes an active programmable lens comprising a first zone configured to provide to the wearer, in standard wearing conditions, a correction of said at least one eye based on said prescription, according to a first adjustable dioptric function, the first adjustable function is depending on said prescription and on vision distance data,
a vision distance data providing means configured to provide first vision distance data corresponding to a first distance between a first object in the environment of the wearer and the active programmable lens, said first object being in a field of view of the active programmable lens, defined by said first zone, and said first distance being taken according to a direction defined by said first zone of the active programmable lens, and
an optical power controller comprising:
   means for storing vision distance data provided by the vision distance data providing means and at least two predetermined optical power states, each predetermined optical power state corresponding to an optical power value relative to a range of vision distance; and
   means for controlling the first adjustable dioptric function of the first zone of the active programmable lens,
      wherein controlling comprises adjusting the first adjustable dioptric function of the first zone of the active programmable lens according to an optical power state based on the provided first vision distance data.

Advantageously, the vision distance data providing means can measure the distance of any objects in the environment of the wearer. Once the environment is measured, the first zone provides the wearer with an optical power based on the first vision distance data of an object to be seen through said first zone without knowing the eyesight direction. This reduces complex gazing direction measurement and the associated computing energy consumption.

The optical power provided to the activable programmable lens is changing solely when the three-dimensional environment of the wearer is changing. A visual environment is generally stable for a long period of time. Therefore, the provided optical power can be provided for a longer period of time, improving the visual comfort of the wearer.

Advantageously, the active programmable lens may comprise a plurality of zones which can be controlled independently to define the optical power of each zone, taking into account the environment of the wearer, and the different distances of the objects configured to be seen through the different zones of the active programmable lens.

According to further embodiments which can be considered alone or in combination:
the active programmable lens comprises a second zone configured to provide to the wearer, in standard wearing conditions, a correction of said at least one eye based on said prescription, according to a second adjustable dioptric function, the second adjustable function depending on said prescription and on vision distance data,
wherein the first zone and the second zone are adjacent and arranged vertically one above the other or horizontally one next to the other, or diagonally one with respect to the other, with respect to the field of view of the active programmable lens,
wherein the vision distance data providing means is configured to provide second vision distance data corresponding to a second distance between said first object in the environment of the wearer and the active programmable lens and said second distance being taken according to a direction defined by said zone of the active programmable lens and said first object,
said first object being in a field of view of the active programmable lens, defined by said second zone, and
wherein the optical power controller comprises means for controlling the second adjustable dioptric function according to an optical power state based on the provided second vision distance data; and/or
the active programmable lens comprising a second zone configured to provide to the wearer, in standard wearing conditions, a correction of said at least one eye based on said prescription, according to a second adjustable dioptric function, the second adjustable function is depending on said prescription and on vision distance data,
wherein the first zone and the second zone are adjacent and arranged vertically one above the other or horizontally one next to the other, or diagonally one with respect to the other, with respect to the field of view of the active programmable lens,
wherein the vision distance data providing means is configured to provide second vision distance data corresponding to a second distance between a second object in the environment of the wearer and the active programmable lens and said second distance being taken according to a direction defined by said zone of the active programmable lens and said object,
said second distance being different from the first distance,
said second object being in a field of view of the active programmable lens, defined by said second zone, and
wherein the optical power controller comprises means for controlling the second adjustable dioptric function according to an optical power state based on the provided second vision distance data; and/or
the active programmable lens comprises n×m zones having respective adjustable dioptric functions,
n and m being integers strictly greater than 1, and 1≤i≤n and 1≤j≤m
the active programmable lens being divided according to a grid having n lines comprising each m adjacent zones arranged horizontally with respect to the field of view of the active programmable lens,
wherein the vision distance data providing means is configured to provide vision distance data corresponding to respective distances d_{i,j} between said first object in the environment of the wearer and the active programmable lens and the active programmable lens and each distance d_{i,j} being taken according to a direction defined by said first object and a corresponding zone z_{i,j} in said grid of the active programmable lens,
said first object being in a field of view of the active programmable lens, defined by said zone z_{i,j}, and
wherein the optical power controller comprises means for controlling the respective adjustable dioptric functions of the zones z_{i,j} of the active programmable lens according to an optical power state based on the provided vision distance data d_{i,j}; and/or
the active programmable lens comprises n×m zones having respective adjustable dioptric functions,
n and m being integers strictly greater than 1, and 1≤i≤n and 1≤j≤m
the active programmable lens being divided according to a grid having n lines comprising each m adjacent zones arranged horizontally with respect to the field of view of the active programmable lens,
wherein the vision distance data providing means is configured to provide vision distance data corresponding to respective distances d_{i,j} between a second object in the environment of the wearer and the active programmable lens and the active programmable lens and each distance d_{i,j} being taken according to a direction defined by said second object and a corresponding zone z_{i,j} in said grid of the active programmable lens,
said distance d_{i,j} being different from the first distance,
said second object being in a field of view of the active programmable lens, defined by said zone z_{i,j}, and
wherein the optical power controller comprises means for controlling the respective adjustable dioptric functions of the zones z_{i,j} of the active programmable lens according to an optical power state based on the provided vision distance data d_{i,j}; and/or
at least two zones of the active programmable lens arranged vertically or diagonally are configured to have different respective dioptric functions; and/or
at least two zones of the active programmable lens, having respective different dioptric functions, overlap over an overlap portion,
wherein over said overlap portion, the optical power changes continuously from the dioptric function of one zone to the dioptric function of the other zone; and/or
the provided distance data with respect to a zone of the active programmable lens corresponds to the distance of an object in the environment of the wearer to be seen in said zone; and/or
the prescription of said at least one eye of the wearer comprises power addition; and/or
the power addition is obtained by an eye care practitioner or said power addition are obtained based on a calibration method achieved by the wearer; and/or
the optical device comprises a frame including the vision distance data providing means, preferably the vision distance data providing means is embedded in said frame of the optical device; and/or
the optical power state according to any of the dioptric function is comprised between −4 D and 4 D; and/or
the vision distance data providing means comprises a distance sensor; and/or
   wherein, the optical power of any of the zone of the active programmable lens, through which a given object is seen by the wearer, is defined by the following equation:

$$D ( x ) = Da - \frac{1}{α} + \frac{1}{x}$$

wherein x is the distance between the given object and the vision distance providing means,
wherein a corresponds to the distance for which the refractivity is acquired, and
wherein Da is the prescribes power for the distance at which the refractivity is acquired; and/or
the optical device comprises a head inclination measuring sensor, wherein the dioptric function corresponding to one zone of the active programmable lens is provided based on an wearer's head inclination measured value; and/or
said head inclination measuring sensor comprises an accelerometer; and/or
the distance sensor and/or the head inclination sensor are configured to perform iterative measurements iteratively, two measurements of a sensor being separated by a predetermined period of time; and/or
the predetermined period of time is manually or automatically tunable.

The disclosure further relates to a method for calibrating an optical device according to the disclosure, the method comprising the following steps:
a) acquiring wearing condition data
b) providing a set of distances data,
c) attributing for each distance of the set of distances a predetermined dioptric function.

According to further embodiments which can be considered alone or in combination:
the method further comprises acquiring wearer prescription data; and/or
the method further comprises acquiring fitting data, prior to providing the set of distances; and/or
the method of calibrating further comprises a step of style of life data acquisition, prior to the provision of the set of distances data; and/or
the method further comprises a step of style of life data acquisition, wherein style of life of the wearer data are acquired; and/or
the set of distances comprises distance corresponding to near vision distance and/or intermediate vision distance and/or far vision distance; and/or
the attributed predetermined dioptric functions take into consideration the prescription of the wearer; and/or
the method for calibrating is performed by machine learning; and/or
the method for calibrating is performed by a wearer; and/or
the method for calibrating performed by the wearer comprises the following steps:
   positioning step, wherein an object is positioned at a given initial distance/position in front of the active programmable lens,
   providing step, wherein a first optical power is provided to a zone of the active programmable lens within which the object is sharply viewed by the wearer at the initial distance/position defined during the positioning step,
   reiteration step, wherein the wearer is asked to adjust the correspondence between a second distance/position of the object and the active programmable lens, and a second optical power provided to said zone,
   adjusting step, wherein the wearer modifies the given initial distance/position to a second distance/position of the object and adjust the first optical power to a second optical power to sharply see the object at the second distance/position, or modifies the optical power provided to a second optical power and adjusting the initial distance from the object to a second distance to sharply see the object with the second objective power, and
   validating this association of the second optical power with the second distance/position; and/or
the validation step consists in maintaining the object in front of the wearer for a given period of time, the given period of time being comprised between 0.5 and 5 s, being preferentially 2 s.

According to an embodiment of the disclosure, the disclosure relates to a computer program product comprising one or more stored sequence of instruction that is accessible to a processor and which, when executed by the processor, causes the processor to carry out the steps of the calibrating method according to the disclosure.

According to an embodiment, the disclosure also relates to a computer readable medium carrying one or more sequences of instructions of the computer program according to the disclosure.

According to an embodiment, the disclosure further relates to a computer-readable storage medium having a program recorded thereon; where the program makes the computer execute the calibrating method of the disclosure.

According to an embodiment, the disclosure relates to a device comprising a processor adapted to store one or more sequence of instructions and to carry out at least one of the steps of the calibrating method according to the disclosure.

The disclosure further relates to the use of the optical device according to the disclosure to slow down myopia, wherein a negative optical power used for adjusting an adjustable dioptric function of at least one zone of the active programmable lens is increased, getting less negative, when the distance with an object to be seen through said at least one zone at a near distance.

### BRIEF DESCRIPTION OF THE DRAWINGS

Embodiments of the disclosure will now be described, by way of example only, and with reference to the following drawings in which:

FIG. 1 illustrates an optical lens according to the disclosure;

FIG. 2a illustrates a first embodiment of an active programmable lens according to the disclosure;

FIG. 2b illustrates a second embodiment of an active programmable lens according to the disclosure;

FIG. 2c illustrates a second embodiment of an active programmable lens according to the disclosure;

FIG. 2d illustrates a third embodiment of an active programmable lens according to the disclosure;

FIG. 3 illustrates different objects being seen through different zones of an active programmable lens according to the disclosure;

FIG. 4 illustrates a flowchart of the calibrating method according to an embodiment of the disclosure;

FIG. 5 illustrates a flowchart of the calibrating method according to an embodiment of the disclosure;

FIGS. 6A and 6B illustrate an embodiment where the active programmable lens is recalibrated;

FIG. 7 is a flowchart of the recalibrating method according to the disclosure;

FIG. 8 illustrates the evolution of the dioptric power of a zone of an active programmable lens according to the disclosure, based on the gazing distance of the wearer.

Elements in the figures are illustrated for simplicity and clarity and have not necessarily been drawn to scale. For example, the dimensions of some of the elements in the figure may be exaggerated relative to other elements to help improve the understanding of the embodiments of the present disclosure.

### DETAILED DESCRIPTION

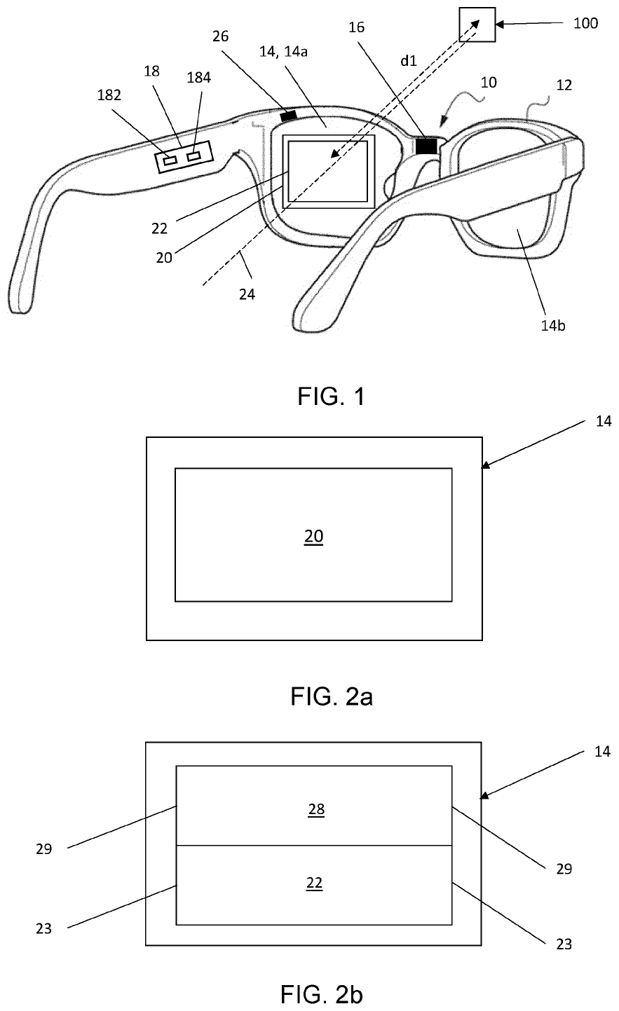

FIG. 1 represents an example of optical device 10 configured to be worn by a wearer. The optical device 10 comprises a spectacle frame 12 configured to house at least one active programmable optical lens 14. Preferably, the frame comprises a first and a second active programmable optical lenses 14a,14b.

The optical device 10 further comprises a vision distance data providing means 16 and an optical power controller 18.

Preferably, the vision distance data providing means 16 and/or the optical power controller 18 are embedded in the frame 12 of the optical device 10.

In an alternative embodiment, the vision distance data providing means 16 and/or the optical power controller 18 are mounted on the frame 12.

The active programmable lens is 14 is configured to provide to the wearer, in standard wearing conditions, a correction of said at least one eye based on said prescription.

At least one of the active programmable lenses is 14a, 14b comprises a prescription portion 20 configured to provide to the wearer, in standard wearing conditions, a correction optical function based on the prescription of the wearer for correcting an abnormal refraction of said eye of the wearer.

The prescription is a set of optical characteristics of optical power, of astigmatism and, where relevant, of addition, determined by an ophthalmologist in order to correct the vision defects of an individual, for example by means of a lens positioned in front of his eye. Generally speaking, the prescription for a progressive addition lens comprises values of optical power and of astigmatism at the distance-vision point and, where appropriate, an addition value.

The wearing conditions are to be understood as the position of the lens element with relation to the eye of a wearer, for example defined by a pantoscopic angle, a Cornea to lens distance, a Pupil-cornea distance, a centre of rotation of the eye (CRE) to pupil distance, a CRE to lens distance and a wrap angle.

The Cornea to lens distance is the distance along the visual axis of the eye in the primary position (usually taken to be the horizontal) between the cornea and the back surface of the lens; for example, equal to 12 mm.

The Pupil-cornea distance is the distance along the visual axis of the eye between its pupil and cornea; usually equal to 2 mm.

The CRE to pupil distance is the distance along the visual axis of the eye between its center of rotation (CRE) and cornea; for example, equal to 11.5 mm.

The CRE to lens distance is the distance along the visual axis of the eye in the primary position (usually taken to be the horizontal) between the CRE of the eye and the back surface of the lens, for example equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example, equal to −8°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example equal to 0°.

An example of standard wearer condition may be defined by a pantoscopic angle of −8°, a Cornea to lens distance of 12 mm, a Pupil-cornea distance of 2 mm, a CRE to pupil distance of 11.5 mm, a CRE to lens distance of 25.5 mm and a wrap angle of 0°.

The active programmable lens 14, 14a, 14b comprises a first zone 22. The first zone 22 is configured to provide to the wearer, in standard wearing conditions, a correction of said at least one eye based on said prescription, according to a first adjustable dioptric function F1.

Preferably, the first portion 22 is comprised in the prescription portion 20.

A first adjustable dioptric function F1 is depending on the prescription and on a vision distance data relative to an object 100 to be seen through the first zone 22, via a gazing direction (illustrated by an axis 24 in FIG. 1).

In an embodiment, the first adjustable dioptric function F1 is also depending on fitting parameters.

Advantageously, using fitting parameters enables to optimize the optical power provided to the first zone 22. Knowing fitting parameters, enable to know where is the field of view defined by the first zone, and adapt the optical power of the first zone 22 based on the vision distance data of the object 100 to be seen in said field of view.

The fitting parameters of the active programmable lens 14 are to be understood as parameters related to the position of the frame 12, on which the lens 14 is mounted, with respect to the face of the wearer.

The fitting parameter may comprise at least one among the pupillary distance, the half pupillary distance, the fitting height, the pantoscopic angle, the far vision point and the near vision point.

The vision distance data providing means 16 is a device configured to provide a first vision distance data corresponding to a first distance d1 between the first object 100 in the environment of the wearer and the active programmable lens 14. The object 100 is in the field of view of the wearer, and more particularly in the field of view of the first zone 22.

The first object 100 is in a field of view of the active programmable lens 14, defined by said first zone 22, and the first distance d1 being taken according to a direction defined by said first zone 22 of the active programmable lens 14. The direction defined by the first zone 22 corresponds to a gazing direction 24 of the wearer passing through the first zone 22 of the active programmable lens 14 and reaching the first object 100.

In an embodiment, the vision distance providing means 16 is a sensor, more preferentially distance sensor.

In an embodiment, the vision distance providing means 16 is a TOF (Time of Flight) 3D sensor, being a small sensor.

In an embodiment, the vision distance providing means 16 is an ultrasound sensor, which can measure in a particular direction (small vertical Field of View and large horizontal Field of View).

In an embodiment, the vision distance providing means 16 is a camera. Camera may include charge-coupled device (CCD), complementary metal-oxide-semiconductor (CMOS), or other photodetectors that include an active area, e.g., including a rectangular or linear or other array of pixels, for capturing images and/or generating video signals representing the images. Camera may be stereo.

In an embodiment, the vision distance providing means 16 comprises a plurality of the above listed devices.

All these devices are small enough to fit in a frame 12.

The optical power controller 18 comprises means for storing 182 and means for controlling 184 the first adjustable dioptric function F1 of the first zone 22.

The means for storing 182 are configured to store vision distance data provided by the vision distance data providing means 16 and at least two predetermined optical power states. Each predetermined optical power state corresponds to an optical power attributed in relation to a value relative to a range of vision distance. A range of vision distance corresponds to near vision, intermediate vision or far vision distance.

In an embodiment, each of the two predetermined optical power states is attached to a specific vision distance.

The means for controlling 184 adjust the first adjustable dioptric function F1 of the first zone 22 of the active programmable lens 14, taking into consideration the at least two predetermined optical power states associated to respective distance and the first distance d1 provided by the distance providing means 16.

The optical power controller 18 adjusts the first adjustable dioptric function F1 of the first zone 22 of the active programmable lens 14 according to an optical power state based on the provided first vision distance data, preferably the first distance d1.

In an embodiment, the optical power controller 18 comprises a processor. In an alternative embodiment, the optical power controller 18 comprises a FPGA (Field Programmable Gate Arrays).

Based on the at least two couple of data, formed by the at least two predetermined optical power states attached respectively to a vision distance, the optical power controller 18 can deduce the optical power to provide to the first zone 22 based on any distance measured by the vision distance data providing means 16.

In an embodiment, the optical power provided to the first zone 22 corresponds to the inverse of the distance d1 measured by the vision distance data providing means 16.

In an embodiment, the variation of the optical power, to be provided in the first zone 22, vary in a linear manner based on the measured distance d1 and the at least two predetermined optical power states attached to a specific distance.

In an embodiment, the range of optical power provided by optical power controller 18 to the first zone 22 is comprised between the at least two predetermined optical power.

In an embodiment the optical power to provide to a zone of the active programmable lens 14 is defined based on the following equation:

$$D ( x ) = Da - \frac{1}{α} + \frac{1}{x}$$

“D(x)” is a function defining the optical power providing for a zone of the programmable active lens 14 through which gaze the wearer at a given object, where “x” is the distance between the given object and the vision distance providing means 16.

“a” corresponds to the distance for which the refractivity of the wearer is acquired, for example measured. “Da” corresponds to the prescribed optical power for the distance “a”, for which the refractivity of the wearer is acquired.

The distances “a” and “x” are measured in meters and Da is measured in diopters.

In an embodiment, Da corresponds to one of the at least two predetermined optical power state stored on the means for storing 182.

In the embodiment, where we consider the far distance prescribed optical power, the term 1/a can be omitted. When we consider prescription for far distance, the wearer is considered to look at the infinite, then the distance “a” is infinite and the term 1/a tends to 0.

Therefore, when considering the equation for a far vision prescribed optical power, we can simplify the equation as follows:

$$D ( x ) = Da + \frac{1}{x}$$

In said embodiment, Da corresponding to the prescribed optical power for far vision is one of the at least two predetermined optical power state stored on the means for storing 182.

Da may be a negative optical power for a myopic wearer.

For example, considering the above-mentioned equation, if the value of Da is equal to 4 D and the wearer is gazing through the first zone 22 at a distance of 4 m, the optical power provided to said zone is 4.25 D.

For example, considering the above-mentioned equation, if the value of Da is equal to 1 D and the wearer is gazing through the first zone 22 at a distance of 1 m, the optical power provided to said zone is 2 D.

For example, considering the above-mentioned equation, if the value of Da is equal to 4 D and the wearer is gazing through the first zone 22 at a distance of 0.4 m, the optical power provided to said zone is 6.5 D.

For example, considering the above-mentioned equation, if the value of Da is equal to 4 D and the wearer is gazing through the first zone 22 at a distance of 0.25 m, the optical power provided to said zone is 8 D.

In an embodiment the prescribed optical power Da corresponds to the optical power adapted for the wearer when looking at a near distance, for example at 0.4 m. Da corresponds to the prescribed optical power of the wearer for near distance of 0.4 m, which is an usual value for eye refraction.

The function D(x) may be adapted for myopic or presbyopic wearers. The presbyopic wearers have each a distance until which their eye is no longer able to accommodate. Said distance is called the reserve accommodative distance x0.

Said reserve accommodative distance x0 is for example considered to be 0.4 m for a person of 45 years old.

In the embodiment where a wearer is presbyopic and is gazing at a distance shorter than the reserve accommodative distance x0, the function D(x), considered to adapt the optical power of the zone of the programmable active lens 14 through which gaze the wearer at a given object located at a distance “x” from the vision distance providing means 16, is the following:

$$D ( x ) = Da - \frac{1}{a} + \frac{1}{x} - \frac{1}{x 0}$$

If the presbyopic wearer is gazing at a distance farther or equal to the reserve accommodative distance x0, the optical power of the zone of the programmable active lens 14 through which gaze the wearer at a given object located at a distance “x” from the vision distance providing means 16, is constant and defined as follows:

$$D ( x ) = Da - \frac{1}{α}$$

FIG. 8 illustrates the evolution of the optical power “D(x)” of the zone of the programmable active lens 14 through which gaze the wearer at a given object located at a distance “x” from the vision distance providing means 16.

In the embodiment illustrated in FIG. 8, the reserve accommodative distance x0 is equal to 66, 67 cm (the accommodative reserve optical power being 1.5 D). The value of the prescribed optical power for near distance vision is −1 D. The distance “a” for which the refractivity is obtained is 0.4 m.

A proximity corresponds to the inverse of a given distance and is measured in m⁻¹. It is to be noted that for the proximity value of 1.5 m⁻¹ and lower, corresponding to the distance x0 and above, the optical power is constant and remains at a power of −2 D.

In the embodiment where the wearer is a young myopic person, and the distance is shorter than a distance corresponding to far gazing, for example lower than 5 m, the function D(x), considered to adapt the optical power of the zone of the programmable active lens 14 through which gaze the wearer at a given object located at a distance “x” from the vision distance providing means 16, is the following:

$$D ( x ) = Da - \frac{1}{α} + \frac{1}{x}$$

In said embodiment, if the young myopic wearer is gazing at far gazing, for example farther than 5 m, the optical power of the zone of the programmable active lens 14 through which gaze the wearer at a given object located at a distance “x” from the vision distance providing means 16, is constant and defined as follows:

$$D ( x ) = Da - \frac{1}{α}$$

In an embodiment, the optical device 10 comprises a head inclination measuring sensor 26. Preferably, the head inclination measuring sensor 26 is an accelerometer or a gyroscope.

The inclination measuring sensor 26 enables to measure static position of the head of the wearer.

A gyroscope measures speed of rotation of the head (a head moving upward/downward, or towards the right/left). These head rotation can also be useful to manage the variation of a first zone 22. A wearer head rotation, in any direction, may modify the objects distances in the environment of the wearer.

The first dioptric function F1 corresponding to the first zone 22 of the active programmable lens 14 comprises a head inclination measured value.

More generally, the head inclination measuring sensor 26 allows to understand the head position and head movements of the wearer.

When the wearer lowers the head towards his feet, in a standing or sitting position, the field of view of the wearer is modified, and no longer comprise far vision. The objects being in the environment of the wearer are either located at near or intermediate vision distances.

The head inclination of the wearer enables to determine the field of view of the wearer. The head inclination measuring sensor 26 adapts the optical power provided to the first zone 22 to a new or anticipated distance.

When the wearer is walking, the optical device needs to optimize far vision distance and intermediate vision distance, which will be the two kinds of distances to be sharply seen to enable the wearer to walk comfortably.

In a particular embodiment, a walking activity may directly be detected by the head inclination measuring sensor 26, such as an accelerometer.

By detecting a walking activity, the dioptric power of the first zone may be adjusted.

When the walking wearer bends the head toward the ground, he no longer uses far distance vision but requests an optimization of the intermediate distance vison to have a sharp vision of the grounds onto which he is walking.

In a particular embodiment, when the wearer, for example is riding a bicycle or walking, does not use near distance vision but request an optimization of the far distance vision. This embodiment can be considered as a “safe displacement mode”. In said mode the near distance vision is disables to prevent undesired distortion and important change in the field of vision of the user. This “safe displacement mode” can be disabled/deactivated when the wearer is doing a task requiring near distance vision, for example typing a text message.

The head inclination measuring sensor 26 enables to determine the head inclination, and thus the active programmable lens 14 through which the wearer is gazing.

In an embodiment, the head inclination measuring sensor 26 enables to measure the position. This method enables to determine whether the wearer has moved according to a given direction between the current measurement and the previous measurement.

The vision distance data providing means 16 and/or the head inclination measuring sensor 26 are configured to perform iterative measurements. Two iterative measurements of a sensor are separated by a predetermined period of time. Preferably, the period of time is comprised between 0.5 s and 5 s.

In an embodiment, iterative measurements are triggered based on a variation of measurements of the head inclination measuring sensor 26 (inducing a movement of the wearer).

In an embodiment, if no variation of measurement of the head inclination measuring sensor 26 is detected, two iterative measurements of a sensor are separated by a predetermined period of time. Preferably, the predetermined period of time is comprised between 1 s and 5 s. Preferably the period of time is customizable.

The customization can be based on the activities performed by the wearer.

The period of time can be manually customized based on an input of the wearer of the optical device according to the disclosure. The manual customization can be achieved based on the presence of one more button on the frame of the optical device.

In the case where the frame comprises a single button dedicated to the customization of the period of time, different pressure on the button could lead to different customized predetermined period of times.

For example, three distinct predetermined period of times can be associated with the pressure of said button. The pressure for a first time on the button leads to the selection of a first predetermined period of time. The pressure for a second time on the button leads to the selection of a second predetermined period of time, being shorter than the first predetermined period of time. The pressure for a third time on the button leads to the selection of a third predetermined period of time, being shorter than the first and the second predetermined period of time. The pressure for a fourth time on the button can lead to a restoration of the third predetermined period of time to an initial period of time corresponding to the period of time previous to the pression for the first time of the button. In an alternative embodiment, a fourth time on the button can lead to a restoration of the third predetermined period of time to the first predetermined period of time.

In an embodiment, the frame of the optical device can comprise two buttons. The pressure on a first button can lead to a decrease of the predetermined period of time by a first given amount of time. The first given amount of time is for example comprised between 0.05 s and 0.3 s. The pressure on a second button can lead to an increase of the predetermined period of time by a second given amount of time. The second given amount of time is for example comprised between 0.05 s and 0.3 s. The first and second given amount of time can be identical or different. The validation of the newly set predetermined period of time can be defined by one of the following events:
the absence of the pressure on the first or second button for a third given amount of time,
a pressure one the first and/or the second button for a fourth given amount of time, or
a pressure one a third button for a fifth given amount of time

The third, fourth and fifth given amount of time is comprised between 0.5 s and 1 s. The third, fourth and fifth given amount of time may be identical or different.

In an embodiment, the first and the second buttons can be replaced by conductive areas detecting the pressure of a finger.

In an embodiment, the first and the second buttons can be replaced by conductive area detecting the pressure of a finger. The swipe movement of a finger of the wearer on said conductive area can be used to increase or decrease the first or second given amount of time.

In another embodiment, the customization of the period of time is automated. Said automation can be achieved by machine learning or by the detection of a pattern relative to the variation of the gazing distance corresponding to the gazing direction to which the wearer looks at.

In an embodiment, the optical device comprises a communication device, wherein the communication is configured to communicate with a distant device via a wired or a wireless data transfer protocol.

The distant device can be used by the wearer to configure the predetermined period of time for which two iterative measurements are performed by the vision distance providing means 16, such as a distance sensor, and/or the head inclination measuring sensor 26.

The distant device may for example be a smartphone, a tablet, a computer, or any electronic device configured to communicate with the optical device (in a wired or a wireless manner).

In an embodiment, the wearer may wear the distant device, such as a wearable device (for example a watch or wristband) incorporating a motion sensor. The motion sensor enables to determine a type of activity performed by the wearer. Based on said mottion sensor, the predetermined period of time can be controlled.

The distant device and the optical device form together a system configured to provide an optical power adapted to the distance of an object positioned in the environment of the wearer.

In an embodiment, the motion sensor detects the motion of the optical device wearer. Based on the detection of a movement of the wearer above a given threshold, the optical power of each of the different zone of the programmable active lens can be configured to enhance far vision gazing.

Advantageously, the use of a motion sensor enables to adapt the predetermined period of time and the optical power of each of the zones of the programmable active lens can be adapted to the activity of the wearer. This enables to improve the comfort of the wearer, without requiring any action of the wearer.

Advantageously, the customization of the predetermined period of time enables to provide a better comfort to the wearer by updating the optical power of the one or more zones of the active programmable lens 14 at a rate adapted to the variation of gazing distance that the wearer experiences.

Another advantage is that the customization of the period of time where the optical power of the one or more zones of the active programmable lens 14 is updated enables a longer life duration of the battery.

In the context, where the period of time is not customizable, said period of time would have to be the shortest as possible in order to try to adapt to quick variations of gazing distances of the wearer.

In an embodiment, the period of time between two measurements of the vision distance data providing means 16 and/or the head inclination measuring sensor 26, is getting more important with time, if no variation are measured.

Advantageously, the time separation enables to reduce the frequency the measurement distance data providing means 16 and/or the head inclination measuring sensor 26, and the calculation of the optical power controller 18, reducing the power consumption of the optical device 10. The optical device 10 can be used for a longer period of time, even for presbyopic or myopic wearers.

Advantageously, providing a frequency of the measurement enables to not alter the comfort of the wearer if an object appears briefly in the field of view of the wearer. This enables avoiding rapid change of the optical power to be provided to the active programmable lens.

In an embodiment, the period of time is programmable. Preferably, the period of time is configured to be adapted to the wearer daily life and/or to its activities.

If a particular activity, including the movement of the head of the wearer, is detected by the head inclination measuring sensor 26 or the vision distance data providing means 16.

For example, the wearer may be reading, walking, watching TV or a computer screen. In all these cases, a specific activity is detected and the dioptric functions of the at least one zone of the active programmable lens 14 is adapted.

A focus change speed on different zones of the active lens may vary depending on the wearer daily life and/or to its activities.

The first dioptric function F1 adapts to the movement of the head of the wearer and the change in the environment of the wearer.

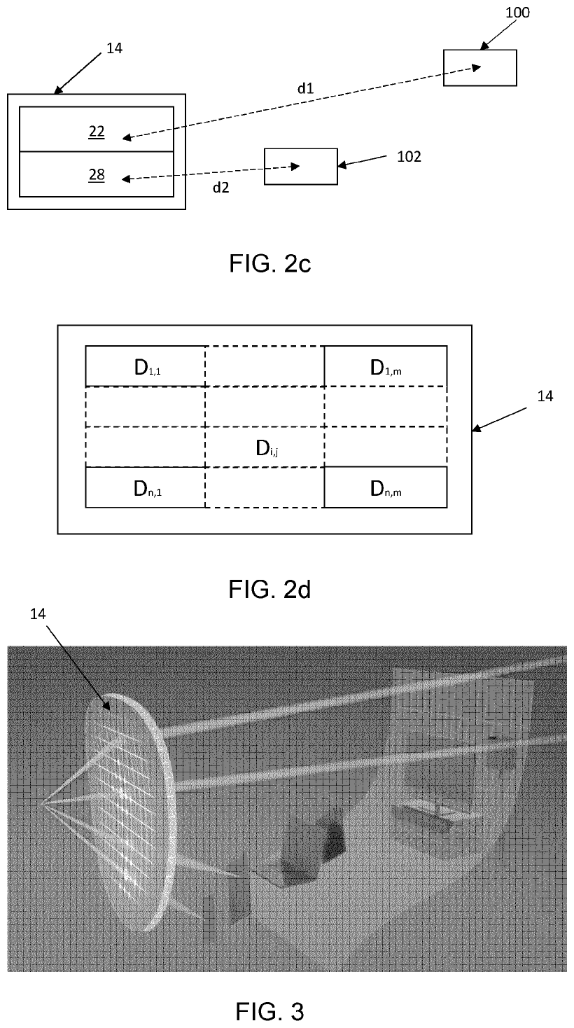

FIGS. 2a to 2c refers to different embodiments of the active programmable lens 14 according to the disclosure.

FIG. 2a illustrates an active programmable lens 14 comprising a single controllable zone, wherein the optical power can be modified. The single controllable zone is the first zone 22.

FIG. 2b illustrates an active programmable lens 14 partitioned in two controllable zones, wherein the optical power can be modified. The two controllable zones comprise the first zone 22 and a second zone 28.

Preferably, the first zone 22 and a second zone 28 are comprised in the prescription portion 20.

In the illustrated embodiment, the first zone 22 is illustrated above the second zone 28. This illustration is non limitative. The second zone 28 may be placed vertically over the first zone 22. The second zone 28 may be placed, horizontally, on the left or on the right of first zone 22.

The first zone 22 may comprise two lateral borders 23. And the first zone 28 may comprise two lateral borders 29.

The second zone 28 placed vertically over the first zone 22, may not have its lateral borders 29 aligned with the lateral borders 23 of the first zone 22. The two zones 22, 28 may be considered to be diagonally adjacent.

Diagonally adjacent zones are particularly interesting for a presbyopic wearer seeking at a near vision position.

In the FIGS. 2b and 2c, the first zone 22 is adapted for far vision, and the second zone 28 is adapted for intermediate and near vision.

The second zone 28 is configured to provide to the wearer, in standard wearing conditions, a correction of the at least one eye based on the prescription, according to a second adjustable dioptric function F2.

The second adjustable dioptric function F2 is determined in a similar manner to the first adjustable dioptric function F1, taking into consideration a second distance d2.

The vision distance data providing means 16 is configured to provide second vision distance data corresponding to the second distance d2 between the object 100 in the environment of the wearer and the active programmable lens 14. The second distance d2 is taken according to a direction defined by gazing direction passing through the second zone 28.

The object 100 is in the field of view of the active programmable lens 14, defined by said second zone 28.

The optical power controller 18 comprises means for controlling 184 the second adjustable dioptric function F2 according to an optical power state based on the provided second vision distance data d2.

The sole parameter varying in the definition of the first adjustable dioptric function F1 and the second adjustable dioptric function F2, is the vision distance d2 provided by the vision distance data providing means 16.

In the embodiment where the same object 100 is seen through the first zone 22 and the second zone 28, the distance d1 is equal to the distance d2, and the same optical power is provided to the first zone 22 and the second zone 28.

FIG. 2c illustrates an embodiment of the active programmable lens 14, comprising the first zone 22 and the second zone 28, as well as the first object 100 and a second 102.

The vision distance data providing means 16 is configured to provide second vision distance data corresponding to a second distance d2 between the second object 102 in the environment of the wearer and the active programmable lens 14. The second distance d2 is taken according to a direction defined by a gaze direction passing through the second zone 28.

The second object 102 is placed at a different location from the first object 100. The second distance d2 is then different from the first distance d1.

The optical power controller adjusts the optical power of the second zone 28 according to the second adjustable dioptric function F2. The first zone 22 and the second zone are provided respectively with a different optical power.

FIG. 2d illustrates an alternative embodiment of the active programmable lens 14. The active programmable lens comprises n×m zones having respective adjustable dioptric functions F_{i,j}.

n and m are integers strictly greater than 1, and 1≤i≤n and 1≤j≤m.

The active programmable lens 14 is divided according to a grid having n lines comprising each m adjacent zones arranged horizontally with respect to the field of view of the active programmable lens 14.

Preferably, the grid of n×m zones is comprised in the prescription portion 20.

The vision distance data providing means 16 is configured to provide vision distance data corresponding to respective distances d_{i,j} between the first object 100 in the environment of the wearer and the active programmable lens 14 and the active programmable lens.

Each distance d_{i,j} is taken according to a direction defined by the first object 100 and the corresponding zone z_{i,j} in said grid of the active programmable lens.

The first object 100 is in a field of view of the active programmable lens 100, defined by the zone z_{i,j}.

The optical power controller 18 comprises means for controlling the respective adjustable dioptric functions F_{i,j} of the zones z_{i,j} of the active programmable lens 14 according to an optical power state based on the provided vision distance data d_{i,j}.

In an embodiment, where a single object 100 present in the field of view of the wearer, all the distances d_{i,j} are identical. Then, all the zones of the grid are provided with the same optical power.

In an embodiment, at least two objects 100, 102 are located respectively at a different distance from the optical device 10. The zones of the programmable active lens 14 through which the first object 100 is seen are provided with a different optical power from the zones through which another object 102, located at a different distance from the first object 100, is seen.

FIG. 3 illustrates a programmable active lens 14 having a grid of n×m active zones through which different objects at different distances are seen.

Preferably, the grid of n×m active zones is formed in the prescription portion 20.

The objects are seen through different zones of the active programmable lens 14. A first object, for example the television, is perceived through the zones dedicated for far vision, and the books are perceived through the zones dedicated for near vision.

In an embodiment, at least two zones of the active programmable lens 14 arranged vertically or horizontally next to each other may have different respective dioptric functions and be provided with different optical power. Two zones being horizontally next to each other belongs to the same line. Two zones being vertically next to each other belongs to different lines and present a contiguous border formed by their lateral borders.

In an embodiment, functions at least two zones of the active programmable lens 14, having respective different dioptric functions may be overlapping over an overlap portion.

For example, a first object being at far distance is seen through a first zone, and a second object being at intermediate distance is seen through a second zone.

In an embodiment, over the overlap portion, the optical power changes continuously from the dioptric function of one zone to the dioptric function of the other zone.

The term “continuously” is interpreted as changing progressively from one optical power to the other optical power, preferably in a linear manner.

In another embodiment, the overlap portion has the optical power of one of the two zones. An hysteresis and/or delay time may be provided to improve the comfort of the wearer.

In an embodiment, the optical power state attributed to each of the first zone 22 or the different zones is comprised between −4 D and 4 D.

In an embodiment, the range of optical power attributed to each of the first zone 22 or the different zones is comprised between 2 D and 3.5 D, preferably 2.5 D and 3 D, based on the different distances measured by the vision distance data providing means 16.

In the sense of the disclosure, power addition refers to the optical power provided to at least one controllable zone of the active programmable lens 14. The power addition can be positive or a negative optical power.

For example, myopic young children would be provided with negative optical power in at least one zone of the active programmable lens 14.

In an embodiment, the power addition can be obtained by an eye care practitioner, eye car professional or an ophthalmologist.

In another embodiment, the power addition can be obtained based on a calibration method achieved by the wearer. Said calibrating method is detailed hereafter.

The disclosure further relates to the method for calibrating the optical device 10.

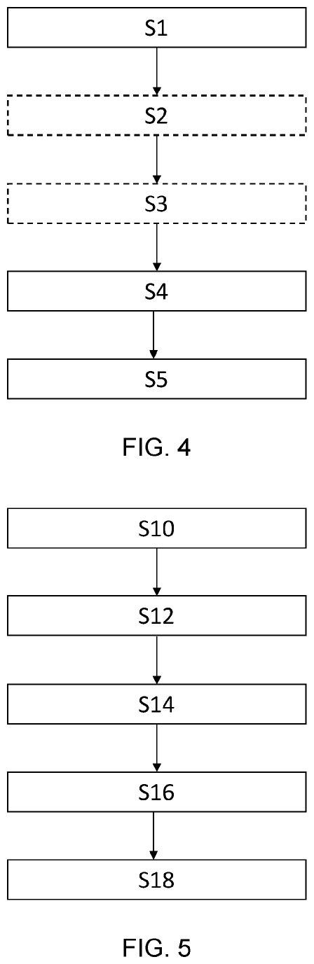

FIG. 4 illustrates a flowchart of a calibrating method according to the disclosure.

The method for calibrating comprises the following steps:
acquiring wearer prescription data (S1),
providing a set of distances data (S4),
attributing for each distance of the set of distances a predetermined dioptric function (S5).

During the prescription data acquisition step S1, a set of optical characteristics comprising optical power and/or of astigmatism are acquired and stored.

During the set of distance data providing step S4, at least two different distances are provided thanks to the vision distance data providing means 16.

The at least two different distances provided are attributed with an optical power, defined by a dioptric function, in step S5.

The at least two distances, provided by the vision distance data providing means 16, are associated with respective at least two predetermined optical power.

In an embodiment, forming an association of at least two provided distances associated with optical powers enables to provide a tendency and to provide linear variation of the optical power to be provided to a zone based on distance of an object measured by the vision distance data providing means 16. At least two couples (provided distance; predetermined optical power) are necessary to determine a linear equation and to determine for every distance measurable by the vision distance data providing means 16, an optical power.

For example, based on first couple associating a first distance D1 with a first optical power P1 and a second couple associating a second distance D2 with a second optical power P2, the value of the optical power to provide to a wearer for any given distance can be derived in a linear manner from a graph having in abscissa, the proximity (the inverse of the distance “x” provided by the vision distance providing means 16) and in ordinate the optical power.

The line is passing by the two points (1/D1, P1) and (1/D2, P2). The directing coefficient and abscissa at the ordinate of the linear line is derived from the two couples (D1, P1) and (D2, P2).

The set of provided distance comprises at least a distance corresponding the categories of near vision distance and/or intermediate vision distance and/or long distance vision. The at least two vision distances belong to two different vision distance categories of the three categories listed previously.

In a particular embodiment, the method further comprises a step (S2) wherein fitting data/parameter relative to the positioning of the optical device on the head of the wearer are acquired.

Obtaining fitting data/parameter enables to know the position of the optical device 10, and more particularly the at least one active programmable lens 14 with respect to the face of the wearer to adapt the dioptric function associated with a zone of the active programmable lens 14.

To have a more optimized optical device 10, it is necessary to know what the field of view of the active zone is, from the wearer eye position point of view. if the optical device 10 slid a bit on the nose of the wearer, the field which is thought to be viewed through the active zone does not correspond to what really sees the wearer looking through this active zone.

In a particular embodiment, the method further comprises a step (S3) wherein style of life of the wearer data are acquired. The style of life refers to the type of activities performed by the wearer.

Taking into consideration the style of life and/or the activities of the wearer influences the distances on which the calibration is performed.

For example, if the wearer performs activities soliciting gazing at far distance, the two calibration distances can be far distances, greater than 4 m.

For example, if the wearer performs activities soliciting gazing at intermediate distance, the two calibration distances can be intermediate distances, comprised between 0.8 m and 4 m.

For example, if the wearer performs activities soliciting gazing at near distance, the two calibration distances can be near distances, lower than 0.8 m.

For a presbyopic wearer, when gazing in far vision, it is better to determine the less concave or more convex refraction.

For a myopic non-presbyopic wearer, it is better to determine the less concave or more convex refraction, regardless of the distance used for the calibration.

Taking into consideration the style of life and/or the activities of the wearer are taken into consideration to adapt the period of time separating two iterative measurement of the distance data providing means 16 and/or the head inclination measuring sensor 26.

In some embodiment, based on the style of life and/or the activities of the wearer, the period of time separating two iterative measurement of the distance data providing means 16 and/or the head inclination measuring sensor 26 increases.

In some embodiment, based on the style of life and/or the activities of the wearer, the period of time separating two iterative measurement of the distance data providing means 16 and/or the head inclination measuring sensor 26 decreases.

Two iterative measurements of a sensor are separated by a predetermined period of time. Preferably, the period of time is comprised between 0.5 s and 5 s.

For example, a person being mostly using intermediate vision, being working on a computer, does not need to have a frequent update relative to any possible environment change occurring in the far field vision of the wearer. In this manner, power consumption can be reduced. In addition, the vision comfort of the wearer is improved, as the active programmable lens 14 is not constantly updating the different activable zone of the lens.

In another example, a wearer is walking, any modification in the near vision field of view would not be comfortable for the above-mentioned reason.

For people achieving specific activities, it might be necessary to frequently switch between at least two of far field vision, intermediate vision and near field vision. In this case, it is necessary to reduce the time period spacing two iterative measurements of the distance data providing means 16 and/or the head inclination measuring sensor 26 to adapt in a quicker manner to the new region viewed by the wearer.

In an embodiment, the period of time is reprogrammable.

In an embodiment, the predetermined dioptric functions take into consideration the prescription of the wearer. Preferably, the prescription, and more particularly the optical power of said prescription, is necessarily to control the optical power of the active zones, taking into consideration the vision of the wearer.

In an embodiment, the calibration method is performed by machine learning.

In an embodiment, the calibration is performed by a wearer.

When the calibrating method is performed by the wearer, the provision of a set of distances data step S4 and the attribution step S5 are performed by the wearer.

FIG. 5 illustrates a flowchart of a calibrating method performed by the wearer according to the disclosure.

More particularly, the wearer achieves the following steps:
positioning step S10, wherein an object is positioned at a given initial distance/position D1 in front of the active programmable lens 14,
optical power providing step S12, wherein a first optical power P1 is provided to a zone of the active programmable lens 14 within which the object is sharply viewed by the wearer at the initial distance/position D1 defined during the positioning step,

After the first association of a first optical power with the object positioned at a given initial distance D1, the wearer proceeds to a second association of a distance with an optical power. At least two distances D1, D2 and associated optical powers P1, P2 are necessary to proceed to the calibration of the optical device 10.

Firstly, in a reiteration step S14, the wearer is asked to adjust the correspondence between a second distance/position D2 of the object and the active programmable lens 14 and a second optical power P2 provided to said zone.

To perform the second association, the wearer, in an adjusting step S16, modifies the given initial distance/position D1 to a second distance/position D2 of the object or modifies the first optical power P1 provided to a second optical power P2, to sharply see the object as the second distance/position D2.

During the adjusting step S16, if the wearer modifies, the given initial distance/position D1 to a second distance/position D2, the wearer is asked to adjust the first optical power P1, until sharply seeing the object at the second distance/position D2. The adjusted power corresponds to the second power P2.

In an embodiment, the first and second buttons used to modify the predetermined period of time can be used to increase or decrease the first optical power P1 of the lens to a second value of the optical power P2.

In another embodiment, the distant device used to modify the predetermined period of time can be used to increase or decrease the first optical power P1 of the lens to a second value of the optical power P2.

Once no modification of the optical power occurs for a given period of time, a validating step S18 occurs to confirm the association of the second optical power P2 with the second distance/position D2.

During the adjusting step S16, if the wearer modifies the first optical power P1 to a second optical power P2, the wearer is asked to adjust to move farther or closer to the object, when the wearer sharply see the object at the second distance/position D2 and does not move for a given period of time.

Once the given period of time is over and the wearer has not moved, a validating step S18 occurs to confirm the association of the second optical power P2 with the second distance/position D2.

The given period of time is for example 5s.

The reiteration step S14, the adjusting step 16 and the validation step can be achieved more than once, for example 3 or 4 times to provide a better calibration of the active programmable lens 14a, 14b.

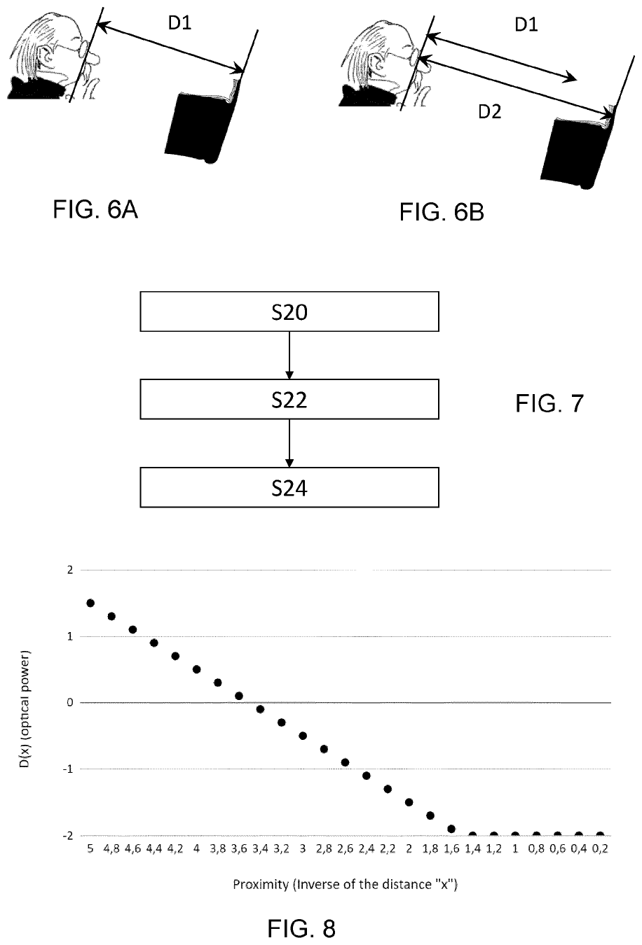

FIG. 6A discloses a wearer reading a book at a first distance D1 with the active programmable lens with a first optical power P1 which was supposed to provide a sharp vision of the book.

For different circumstances, there might be a need to recalibrate the active programmable device, for example the acuity of the user has changed. Rather than getting a new device, it is possible to recalibrate the active programmable lens.

FIG. 7 illustrates a flowchart of the recalibrating method according to the disclosure.

The recalibration method comprises the following step:
a recalibration activation step S20, wherein the wearer launches a recalibration process,
a modification step S22, wherein the wearer modifies either a first distance D1 to a second distance D2 or the activable power of an object, a book for example, to see said object clearly through the active programmable lens, and
a validation step S24, wherein the modified second distance D2 is associated with the first optical power P1 or the modified second optical power P2 is associated to the D1.

FIG. 6B illustrates an embodiment wherein the wearer moves the book from a first distance to a second distance D2, while maintaining the optical power to the first optical power P1.

Following, the modification from the first distance D1 to the second distance D2, the second distance D2 is associated with the first optical power P1. The active programmable lens is then recalibrated.

In this embodiment, the active programmable lens is recalibrated based on a change of the distance of the item to be seen through the active programmable lens.

In an alternative embodiment, the wearer may maintain the object, for example the book at the first distance D1, and modify the first optical power P1 to a second optical power P2. Once the validation step is achieved the first distance D1 is associated with the second power P2.

In this alternative embodiment, the active programmable lens is recalibrated based on a change of optical power

The initial distance D1 and the second distance D2 are different distances.

The optical power P1 and the second optical power P2 are different.

The validation step S18 consists in maintaining the object in front of the wearer for a given period of time. The given period of time may be comprised between 0.5 and 5s, being preferentially 2 s.

In an embodiment, the initial distance D1 could be a long distance (for example (for example 10 m or more) and D2 could be an intermediate distance (for example 1 m). A third initial distance D3 could be considered for the calibration, being a short distance (for example 0.4 m).

Advantageously, with such a calibration involving a far distance, an intermediate distance and a near distance, it is possible to derive the prescribed optical powers of the wearer for each of these kinds of distances, or at least an approximation of said prescribed optical powers.

Thanks to said calibration, a prescription provided by an eyecare practitioner is not mandatory.

Advantageously, an optical device according to the disclosure could be provided without knowing the prescription of the wearer.

In the case where solely two couples, comprising first couple associating a first distance D1 with a first optical power P1 and a second couple associating a second distance D2 with a second optical power P2, the value of the optical power to provide to a wearer for any given distance can be derived in a linear manner,

The value of the optical power to be provided can be derived from a graph having in abscissa, the proximity (the inverse of the distance “x” provided by the vision distance providing means 16) and in ordinate the optical power.

The line passing by the points (1/D1, P1) and (1/D2, P2) (wherein the distance defines the abscissa and the optical power defines the ordinate). The directing coefficient and abscissa at the ordinate of the linear line is derived from the two couples (D1, P1) and (D2, P2).

In the embodiment where more than two couples of distances associated respectively with an optical power are provided by the wearer during the calibration, the value of the optical power to provide to a wearer for any given distance can be derived in a linear, piecewise linear or a polynomial manner.

This can be derived thanks to a curve on a graph having in abscissa, the proximity (the inverse of the distance “x” provided by the vision distance providing means 16) and in ordinate the optical power.

The curve can be linear and derived using linear regression based on each of the couples associating a distance with an optical power or a subset of said couples.

In another embodiment, the curve is curvilinear and can be derived using a polynomial fit.

The disclosure further relates to the use of the optical device 10 for myopic and presbyopic people.

For presbyopic wearers having still a certain amount of accommodation, it is possible to add the extra optical power where needed using an optical device 10 according to the disclosure. The adjustment of the dioptric function provided to the active zone or zones of the active programmable lens 14 is based on the prescription and takes into consideration the wearer visual deficiencies.

The optical device 10 may be provided to younger wearers having visual fatigue symptoms, having a complement of optical power provided by the optical device 10 in specific visual situations such as near vision, driving, computer or screen use.

The optical device 10, according to the disclosure, may be used to slow down myopia, wherein a negative optical power is increased in at least one active zone of the active programmable lens 14, getting less negative, when the distance data providing means 16 senses an object at a distance corresponding to a near vision distance.

Advantageously, using the optical device 10 and reducing the optical power (the lenses being less negative, closer to plano lenses) of an active zone seen in near vision, make it is possible to reduce accommodation effort of a myopic children during near vision task to avoid the reduction of spherical aberration.

The optical power increased in the zone, being less negative, enables to reduce peripheral defocus. As accommodation of the eye will be lower, it permits to avoid spherical accommodation reduction.

In a high luminance environment, the human eye has a wider depth of focus, variations of focus of the active programmable lens can be reduced or suppressed to have a stable power value and minimize distortion and lateral blur.

The distance of the surrounding elements and the curvature of the retina has to be taken into account, to adjust the peripheral power of the lens. Especially for myopic wearers, it is recommended to keep a light myopic defocus, by focusing the image slightly in front of the retina, or by mimicking peripheral defocus of an emmetrope person without a correcting lens.

When looking at far vision, for emmetropic eye, the image is sharp on central retina, and getting blurred on periphery because of prolateness of the peripheral retina (hyperopic defocus).

When looking at near vision, the eye accommodates to obtain a sharp image on the central retina.

The peripheral retina will perceive objects in the environment of the wearer, being further away. So, on peripheral retina, the blur is reduced compared to far vision.

The disclosure has been described above with the aid of embodiments without limitation of the general inventive concept. Moreover, the embodiments of the disclosure may be combined without any restriction.

Many further modifications and variations will suggest themselves to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. An optical device adapted to be worn by a wearer, the wearer having a prescription for at least one eye, the optical device comprising at least:
an active programmable lens comprising a first zone configured to provide to the wearer, in standard wearing conditions, a correction of said at least one eye based on said prescription, according to a first adjustable dioptric function, the first adjustable dioptric function depending on said prescription and on vision distance data;
a vision distance data providing means configured to provide first vision distance data corresponding to a first distance between a first object in the environment of the wearer and the active programmable lens, said first object being in a field of view of the active programmable lens, defined by said first zone, and said first distance being taken according to a direction defined by said first zone of the active programmable lens; and
an optical power controller comprising:
means for storing vision distance data provided by the vision distance data providing means and at least two predetermined optical power states, each predetermined optical power state corresponding to an optical power value relative to a range of vision distance; and
means for controlling the first adjustable dioptric function of the first zone of the active programmable lens, wherein the controlling comprises adjusting the first adjustable dioptric function of the first zone of the active programmable lens according to an optical power state based on the provided first vision distance data.

2. The optical device according to claim 1, wherein the active programmable lens comprises a second zone configured to provide to the wearer, in standard wearing conditions, a correction of said at least one eye based on said prescription, according to a second adjustable dioptric function, the second adjustable dioptric function depending on said prescription and on vision distance data,
wherein the first zone and the second zone are adjacent and arranged vertically one above the other or horizontally one next to the other, or diagonally one with respect to the other, with respect to the field of view of the active programmable lens,
wherein the vision distance data providing means is configured to provide second vision distance data corresponding to a second distance between said first object in the environment of the wearer and the active programmable lens and said second distance being taken according to a direction defined by said zone of the active programmable lens and said first object,
said first object being in a field of view of the active programmable lens, defined by said second zone, and
wherein the optical power controller comprises means for controlling the second adjustable dioptric function according to an optical power state based on the provided second vision distance data.

3. The optical device according to claim 1, wherein the active programmable lens comprises a second zone configured to provide to the wearer, in standard wearing conditions, a correction of said at least one eye based on said prescription, according to a second adjustable dioptric function, the second adjustable function is depending on said prescription and on vision distance data,
wherein the first zone and the second zone are adjacent and arranged vertically one above the other or horizontally one next to the other, or diagonally one with respect to the other, with respect to the field of view of the active programmable lens,
wherein the vision distance data providing means is configured to provide second vision distance data corresponding to a second distance between a second object in the environment of the wearer and the active programmable lens and said second distance being taken according to a direction defined by said zone of the active programmable lens and said object,
said second distance being different from the first distance, said second object being in a field of view of the active programmable lens, defined by said second zone, and
wherein the optical power controller comprises means for controlling the second adjustable dioptric function according to an optical power state based on the provided second vision distance data.

4. The optical device according to claim 1, wherein the active programmable lens comprises n×m zones having respective adjustable dioptric functions,
n and m being integers strictly greater than 1, and 1≤i≤n and 1≤j≤m
the active programmable lens being divided according to a grid having n lines comprising each m adjacent zones arranged horizontally with respect to the field of view of the active programmable lens,
wherein the vision distance data providing means is configured to provide vision distance data corresponding to respective distances d_{i,j} between said first object in the environment of the wearer and the active programmable lens and the active programmable lens and each distance d_{i,j} being taken according to a direction defined by said first object and a corresponding zone z_{i,j} in said grid of the active programmable lens,
said first object being in a field of view of the active programmable lens, defined by said zone z_{i,j}, and
wherein the optical power controller comprises means for controlling the respective adjustable dioptric functions of the zones z_{i,j} of the active programmable lens according to an optical power state based on the provided vision distance data d_{i,j}.

5. The optical device according to claim 1,
wherein the active programmable lens comprises n×m zones having respective adjustable dioptric functions,
n and m being integers strictly greater than 1, and 1≤i≤n and 1≤j≤n
the active programmable lens being divided according to a grid having n lines comprising each m adjacent zones arranged horizontally with respect to the field of view of the active programmable lens,
wherein the vision distance data providing means is configured to provide vision distance data corresponding to respective distances d_{i,j} between a second object in the environment of the wearer and the active programmable lens and the active programmable lens and each distance d_{i,j} being taken according to a direction defined by said second object and a corresponding zone z_{i,j} in said grid of the active programmable lens,
said distance d being different from the first distance,
said second object being in a field of view of the active programmable lens, defined by said zone z_{i,j}, and
wherein the optical power controller comprises means for controlling the respective adjustable dioptric functions of the zones z_{i,j} of the active programmable lens according to an optical power state based on the provided vision distance data d_{i,j}.

6. The optical device according to claim 2, wherein at least two zones of the active programmable lens, having respective different dioptric functions, overlap over an overlap portion, wherein over said overlap portion, the optical power changes continuously from the dioptric function of one zone to the dioptric function of the other zone.

7. The optical device according to claim 1, wherein the prescription of said at least one eye of the wearer comprises power addition.

8. The optical device according to claim 1, wherein the power addition is obtained by an eye care practitioner or said power addition are obtained based on a calibration method achieved by the wearer.

9. The optical device according to claim 1, wherein the optical device comprises a frame including the vision distance data providing means, preferably the vision distance data providing means is embedded in said frame of the optical device.

10. The optical device according to claim 1, wherein the vision distance data providing means comprises a distance sensor.

11. The optical device according to claim 1, wherein, the optical power of any of the zone of the active programmable lens, through which a given object is seen by the wearer, is defined by the following equation:
$$D ( x ) = Da - \frac{1}{α} + \frac{1}{x}$$
wherein x is the distance between the given object and the vision distance providing means, wherein a corresponds to the distance for which the refractivity is acquired, and wherein Da is the prescribes power for the distance at which the refractivity is acquired.

12. The optical device according to claim 1, further comprising a head inclination measuring sensor, wherein the dioptric function corresponding to one zone of the active programmable lens is provided based on a wearer's head inclination measured value.

13. The optical device according to claim 10, wherein the distance sensor and/or the head inclination sensor are configured to perform iterative measurements iteratively, two measurements of a sensor being separated by a predetermined period of time.

14. The optical device according to claim 13, wherein the predetermined period of time is manually or automatically tunable.

15. A method for calibrating an optical device according to claim 1, the method comprising:
a) acquiring wearing condition data;
b) providing a set of distances data; and
c) attributing for each distance of the set of distances a predetermined dioptric function.

16. The method according to claim 15, further comprising acquiring wearer prescription data.

17. The method according to claim 15, further comprising acquiring wearing condition data, prior to providing the set of distances.

18. The method according to claim 15, wherein the attributed predetermined dioptric functions take into consideration the prescription of the wearer.

19. The method according to claim 15, further comprising a step of style of life data acquisition, wherein style of life of the wearer data are acquired.

20. The method according to claim 15, wherein the method is performed by a wearer and comprises:
positioning step, wherein an object is positioned at a given initial distance/position in front of the active programmable lens;
providing step, wherein a first optical power is provided to a zone of the active programmable lens within which the object is sharply viewed by the wearer at the initial distance/position defined during the positioning step;
reiteration step, wherein the wearer is asked to adjust the correspondence between a second distance/position of the object and the active programmable lens, and a second optical power provided to said zone;
adjusting step, wherein the wearer modifies the given initial distance/position to a second distance/position of the object and adjust the first optical power to a second optical power to sharply see the object at the second distance/position, or modifies the first optical power provided to a second optical power and adjusting the initial distance from the object to a second distance to sharply see the object with the second objective power; and
validating this association of the second optical power with the second distance/position.
